(19) United States
(12) Patent Application Publication
(10) Pub. No.: US 2003/0063581 A1
(43) Pub. Date: Apr. 3, 2003

(54) System, method and apparatus for seamless interaction between wireless local area network and wireless packet data network

(76) Inventors: Vyankatesh Shanbhag, Plano, TX (US); Jogen Kanubhai Pathak, Irving, TX (US); Shridhar Krishnamurthy, Coppell, TX (US); Rangaprasad Govindarajan, Plano, TX (US); Janet H. Lind, Plano, TX (US)

Correspondence Address: R. Scott Rhoades, Strasburger & Price, L.L.P., Suite 4300, 901 Main Street, Dallas, TX, 75202-3794, US

(21) Appl. No.: 10/263,228

(22) Filed: Oct. 2, 2002

Related U.S. Application Data
(60) Provisional application No. 60/326,663, filed on Oct. 2, 2001.
(60) Provisional application No. 60/348,190, filed on Nov. 7, 2001.

(51) Int. Cl. H04Q 7/00; H04L 12/66

(52) U.S. Cl. 370/328; 370/352

(57) ABSTRACT

A system and method for seamless interaction between a wireless local network (WLAN) and a wireless packet data network is presented herein. A wireless content switch is placed between the WLAN and wireless packet data network. The wireless content switch authenticates the wireless clients of the WLAN and assists nodes in the wireless packet data in authenticating the wireless client.

### CROSS-REFERENCE TO RELATED APPLICATIONS

This application claims the priority benefit of U.S. Provisional Application for Patent, Serial No. 60/326,663, entitled “System, Method, And Apparatus For Seamless Interaction Between Wireless Local Area Network And Wireless Packet Data Network,” filed on Oct. 2, 2001, and claims the priority benefit of U.S. Provisional Application for Patent, Serial No. 60/348,190, entitled “System and Method For Seamless Interaction Between Wireless Local Area Network And Wireless Packet Data Network,” filed on Nov. 7, 2001, which are hereby incorporated by reference for all purposes.

### STATEMENT REAGARDING FEDERALLY SPONSORED RESEARCH/DEVELOPMENT

Not Applicable.

### FIELD

The present application relates to wireless packet data networks, and more particularly to, seamless transfer from a wireless local area network to a public wireless packet date network and vice versa.

### BACKGROUND

Public wireless networks which were originally designed for public wireless telephone services are being adapted for public wireless data services as well. The public wireless networks are adapted for wireless data services by linking the wireless network to the preexisting wired network. Protocols such as General Packet Radio Service (GPRS) and Enhanced Data for Global System for Mobile Communications (GSM) Evolution (EDGE) were developed for facilitate transmission of data packets over the wireless network.

Additionally, Wireless Local Area Networks (WLAN) are deployed which cover smaller, localized regions, such as corporate campuses, and are generally private networks which are only usually accessible for those associated with the private organization operating the WLAN.

Private WLAN networks offer a number of advantages. For example, certain content can be made available on the WLAN which cannot be made available on public wireless packet data networks because each of the subscribers to the WLAN are known to be associated with the private organization operating the WLAN. Additionally, private WLANs can concentrate a variety of wireless infrastructure over a smaller area, thereby providing a better wireless link and higher bandwidth.

Due to the more localized area of coverage by a WLAN, subscribers are likely to physically exit the area of coverage. Upon exiting the area of coverage by the WLAN, the subscriber can utilize the services of a public wireless packet data network. There are, however, a number of problems associated with transitioning from a WLAN to a public wireless packet data network. One of the primary problems is that WLANs and public wireless packet data networks are disjointed. Therefore, when transferring from the coverage area to another coverage area, the user must terminate the session with the WLAN and establish a session with the public wireless packet data network. Additionally, the WLAN and public wireless packet data networks also have disjointed accounting and billing mechanism which do not allow credit for one network to be applied for services of another network. The foregoing problems are also encountered when the user transfers from the public wireless packet data network to a WLAN, and from a first WLAN to a second WLAN.

Accordingly, it would be desirable if users from a first WLAN could transfer to a public wireless packet data network, or second WLAN, and vice versa in a more seamless manner.

### SUMMARY

A system and method for servicing wireless clients is presented herein. A wireless content switch receives requests for internet access for a wireless client. The wireless content switch authenticates the wireless client and transmits an identifier which identifies the wireless packet data network through which the wireless client accesses the internet.

### BRIEF DESCRIPTION OF THE DRAWINGS

FIG. 1 is a block diagram of an exemplary wireless content switch;

FIG. 2 is a block diagram of an exemplary communication system;

FIGS. 3a and 3b are signal flow diagrams describing the operation of the communication network, wherein a wireless client moves from a Wireless Local Area Network to the public wireless packet data network;

FIG. 4 is a signal flow diagram describing the operation of the communication network, wherein a wireless client moves from the public wireless packet data network to the wireless local area network;

FIG. 5 is a block diagram of an alternate communication network; and

FIG. 6 is a signal flow diagram describing the operation of the communication network.

### DETAILED DESCRIPTION OF THE DRAWINGS

In the descriptions which follow, like parts are marked throughout the specification and drawings with the same numerals, respectively. The drawing figures are not necessarily drawn to scale and certain figures may be shown in exaggerated or generalized form in the interest of clarity and conciseness.

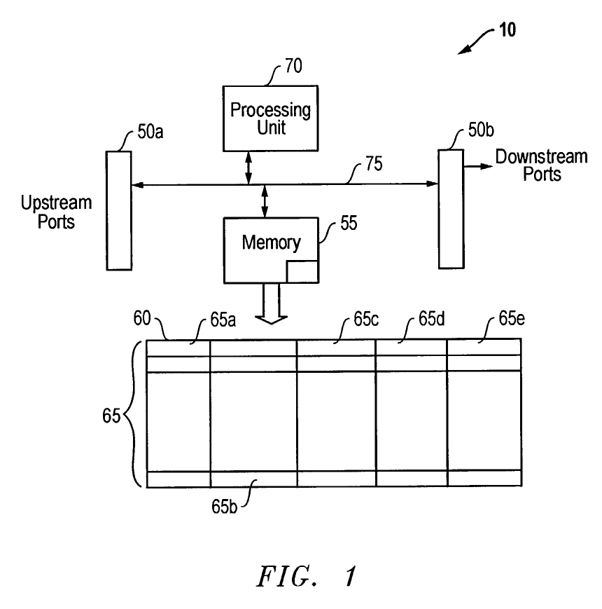

Referring now to FIG. 1, there is illustrated a block diagram of an exemplary wireless content switch 10 for serving wireless clients accessing a wired network, such as the internet. The wireless content switch 10 includes any number of upstream ports 50a and downstream ports 50b. The upstream ports 50a facilitate connection of the wireless content switch 10 towards a wired network via a trunk line, such as, for example, a T1, E1, or an Ethernet connection, to name a few. Similarly, the downstream ports 50b facilitate connection of the wireless content switch 10 towards wireless clients served by the wireless content switch 10. Connection of the ports permits receipt and transmission of various signals that are passed between the wireless client and the wired network, as will be described below.

The wireless content switch 10 includes a memory 55 for storing a memory table 60. The memory table 60 includes any number of records 65, each of which are associated with a particular wireless client receiving wireless packet data services from the wireless content switch 10.

Each record contains a subscriber profile indicator 65a, a Packet Temporary Mobile Subscriber Identification (P-TMSI) indicator 65b, a Routing Area Identifier (RAI) indicator 65c, an Internet Protocol (IP) address indicator 65d, and a forwarding Internet Protocol (IP) address indicator 65e. Each wireless client receiving services from a wireless packet data services network is associated with a subscriber. Information about the subscriber, such as identification, authentication, and accounting information are stored in what is known as a subscriber profile. The subscriber profile indicator 65a stores the subscriber profile of the subscriber for the wireless client which is associated with the record 65, including an International Mobile Subscriber Identification (IMSI) number.

Although each wireless client is associated with an International Mobile Subscriber Identification (IMSI) number, for security reasons, the wireless content switch 10 allocates a Packet Temporary Mobile Subscriber Identification (P-TMSI) number which identifies the wireless client during the course of a data session. The P-TMSI is stored in the P-TMSI indicator 65b.

Wireless clients can access a wired network through a variety of wireless packet data networks. These networks include both wireless local area networks (WLAN), and public wireless packet data networks. Each WLAN and portions of public wireless packet data networks are identified by a Routing Area Identifier (RAI). The routing area identifier of the WLAN or portion of the public wireless packet data networks used by the wireless client associated with the record 65 is stored at the RAI indicator 65c.

During a data session, each wireless client is also associated with a packet data address known as an Internet Protocol (IP) address. The IP indicator 65d stores the IP address of the wireless client associated with the record 65. Additionally, the wireless client can also be associated with a forwarding IP address which is stored as the Forwarding IP Address indicator 65e.

The memory 55 can also store a plurality of instructions executable by a processing unit 70. The memory 55, processing unit 70, upstream ports 50a, and downstream ports 50b are interconnected by a bus 75 which facilitates the transmission of signals therebetween.

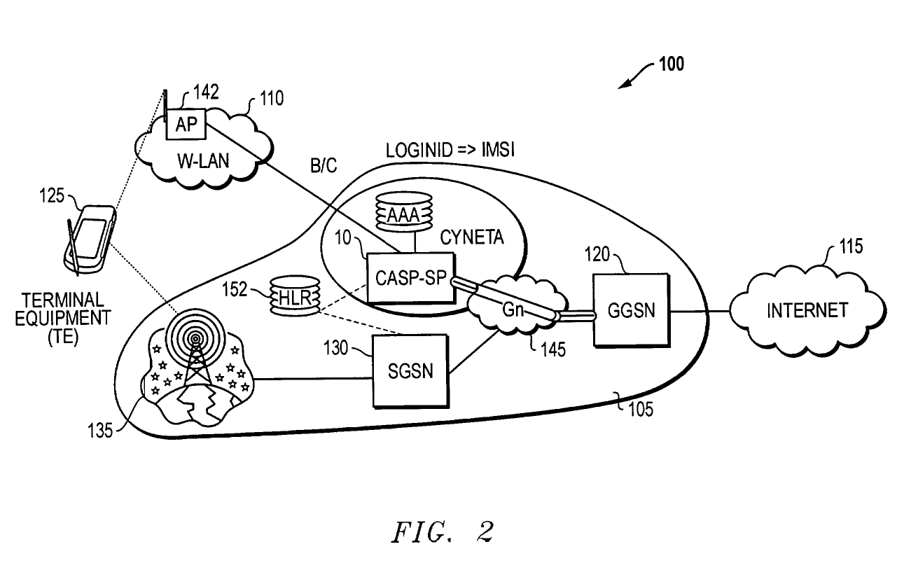

Referring now to FIG. 2, there is illustrated a block diagram of an exemplary communication network, referenced generally by the numeric designation 100. The communication network 100 includes a public wireless packet data network 105 in accordance with Global System for Mobile Communications (GSM) specifications with GPRS functionality and a wireless local are network (WLAN) 110.

The public wireless packet data network 105 is interfaced with a wired network 115 by any number of Gateway GPRS Support Nodes (GGSN) 120. Each GGSN 120 is associated with any number of IP addresses which the GGSN 120, in turn allocates to wireless client 125, either dynamically, or on a static basis. The GGSN 120 also interfaces the WLAN 110 to the wired network 115 as will be described below.

The public wireless packet data network 105 provides packet data services to geographical areas which are divided into routing areas. Each routing area is associated with a particular Serving GPRS Support Node (SGSN) 130. Each SGSN 130 is interconnected to the GGSN 120 by a backbone network 145. Each SGSN 130 is associated with any number of base station systems 135. The base station system 135 comprises the radio transceiver equipment which transmits and receives signals to and from the wireless client 125. Base station systems 135 maintain radio frequency communications within a geographic area known as a cell 140 (not shown).

The WLAN 110 is a wireless data network which serves a localized region, such as a corporate campus, or the like. The WLAN 110 includes a network of access points 142 which overlay a LAN 150. The access points 142 include radio equipment permitting wireless clients 125 to establish a wireless link with the LAN 150.

The WLAN 110 is connected to the public wireless packet data network 105 via a wireless content switch 10. The wireless content switch 10 is connected to the WLAN 110 via downstream port 50b and is connected to the public wireless packet data network 105 via upstream port's 50a connection to the backbone network 145. The foregoing connections permit the wireless content switch 10 to receive and transmit signals, to and from the WLAN 110 and the public packet data network 105. The wireless content switch 10 is also connected to the home location register (HLR) 152 which is also connected to the SGSN 130.

The wireless content switch 10 allows wireless clients served by the WLAN 110 to access the internet 115 via the GGSN 120 of the public wireless packet data network 105. The wireless content switch 10 also permits the wireless client 125 to seamlessly transfer from the WLAN 110 and the public wireless packet data network 105, as will be described below.

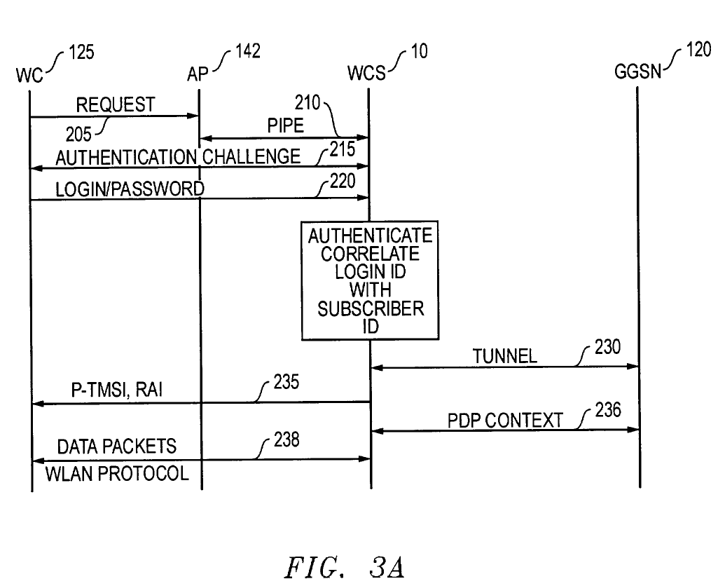

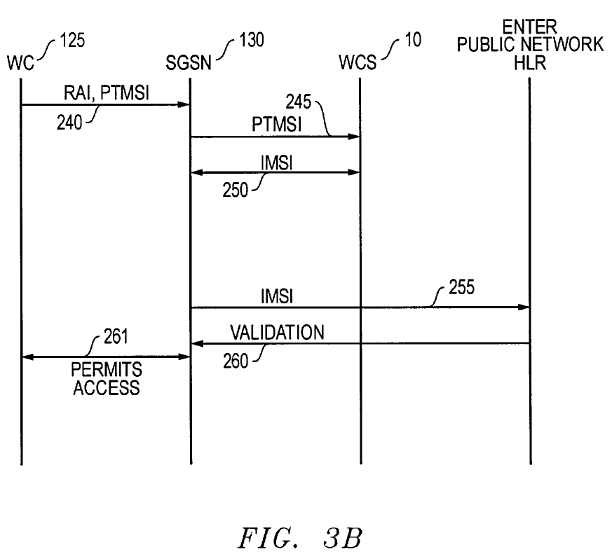

Referring now to FIGS. 3a and 3b, there are illustrated signal flow diagrams describing the operation of the communication network. As is shown in FIG. 3a, a wireless client 125 initiates a data session with the WLAN 110 by transmitting a request message (signal 205) to the access point 142. Responsive thereto, the access point 142 attempts to establish a pipe to the internet via the wireless content switch 10 by establishing a pipe connection to the wireless content switch 10 (signal 210). The authentication capabilities of the access point 142 are preferably disabled.

The pipe connection is detected by the wireless content switch 10 at the downstream port 50b. Upon detection of the pipe, the wireless content switch 10, via downstream port 50b, sends authentication challenge signal(s) (signal 215) to the wireless client 125 to establish and verify the identity of the subscriber associated with the wireless client 125. The wireless client 125 responds to the authentication challenge signal(s) 215 by transmitting a login identification and a password associated therewith (signal 220).

The wireless content switch 10 authenticates the wireless client 125 (action 225) using the login identification and password provided in signal 220 by matching the foregoing information with the subscriber profile 65a of a record associated with the wireless client 125. During the authentication, the wireless content switch 10 correlates the login identification provided with the International Mobile Subscriber Identifier (IMSI) associated therewith.

Upon authentication of the wireless client 125, the wireless content switch 10 completes the pipe (or tunnel) (signal 230) to the internet 115 via the GGSN 120 from upstream port 50a. Additionally, the wireless content switch 10 transmits via downstream port 50b a Packet Temporary Mobile Subscriber Identifier (P-TMSI) and a Routing Area Identifier (RAI) (signal 235) to the wireless client 125. The RAI is an identifier which uniquely identifies the WLAN 110. The wireless client 125 can then continue to access the internet 115 via the WLAN 110. The foregoing P-TMSI and RAI are stored in the P-TMSI indicator 65b and RAI indicator 65c of the record 65 associated with the wireless client 125. The wireless content switch 10 establishes a PDP content (signal 236) with the GGSN 120 and forwards data packets (signal 238) to the wireless client 125 using the protocol of the WLAN 110.

However, as noted above, the wireless client 125 may move outside the area of coverage of the WLAN 110. Where the wireless client 125 moves outside the coverage area of the WLAN 110, the wireless client 125 can continue the data session over the internet 115 using the public packet data services network 105, wherein the wireless client 125 has a subscription to the public packet data services network 105.

As is shown in FIG. 3b, when the wireless client 125 moves outside the area of coverage of the WLAN 110, the wireless client 125 transmits the P-TMSI and the RAI (signal 240) to the SGSN 130. As noted above, the RAI uniquely identifies the WLAN 110. The SGSN 130 uses the RAI to identify the WLAN 110 and the wireless content switch 10 serving the identified WLAN 110. The SGSN 130 transmits the P-TMSI (signal 245) to the wireless content switch 10. The wireless content switch 10 receives the P-TMSI at the upstream port 50a. The wireless content switch 10 uses the P-TMSI to retrieve the record 65 associated with the wireless client. Upon retrieving the record 65 associated with the wireless client 125, the wireless content switch 10 takes the IMSI from the subscriber profile indicator 65a and returns the IMSI to the SGSN 130 via upstream port 50a (signal 250). The SGSN 130 then transmits (signal 255) the IMSI to a home location register (HLR) 152 in the public network which validates the user and sends a validation signal (signal 260) to the SGSN 130. Responsive thereto, the SGSN 130 permits (signal 261) the wireless client 125 to access the internet 115.

Additionally, while utilizing the public packet data services network 105, the wireless client 125 can enter the area of coverage of the WLAN 110. When the wireless client 125 enters the coverage area of the WLAN 110, the wireless client can utilize the resources of the WLAN 110 by seamlessly transferring from the public wireless packet data services network 105.

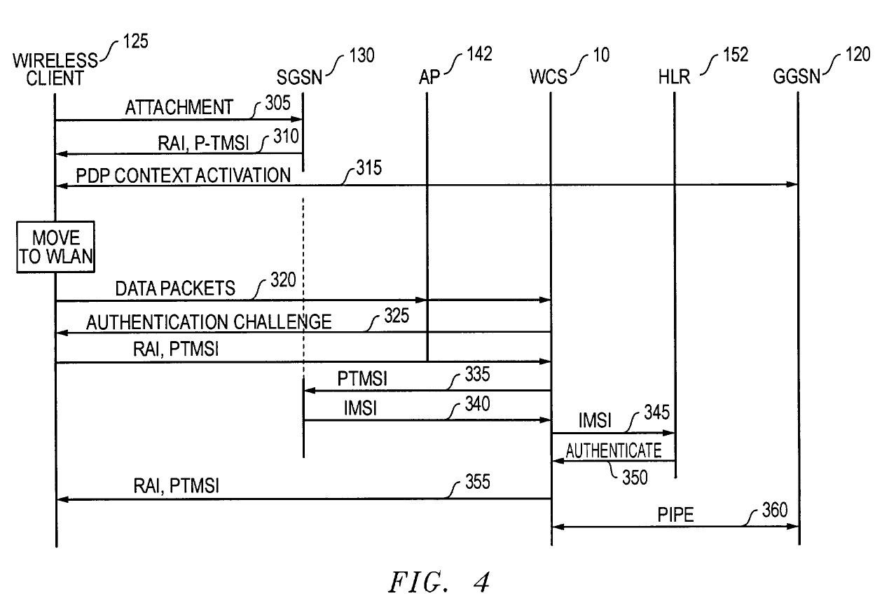

Referring now to FIG. 4, there is illustrated a signal flow diagram describing the operation of the communication network, wherein a wireless client 125 moves into an area served by the WLAN 110. During activation of the wireless client 125 in the public wireless packet data services network 105, the wireless client 125 transmits an attach message (signal 305) to the SGSN 130 which includes the IMSI associated with the wireless client 125. Responsive thereto, the SGSN 130 validates the IMSI and transmits (signal 310) a RAI and a P-TMSI allocated for the wireless client 125 to the wireless client 125. Additionally, the wireless client 125 and the SGSN 130 transmit signals pursuant to PDP Context Activation (signal 315), wherein the wireless client 125 is allocated an Internet Protocol (IP) address.

When the wireless client 125 enters the coverage area of the WLAN 110, the wireless client 125 attempts to transmit data packets (signal 320) to the access point 142 which forwards the data packets to the wireless content switch 10. Each of the data packets transmitted by the wireless client 125 includes the IP address associated with the wireless client 125 as the origination address. The wireless content switch 10 receives the data packets at the downstream port 50b and monitors the origination address of each of the packets which are transmitted through the wireless content switch 10 with the IP addresses stored in the IP address indicators 65d of the memory table 60. Wherein a packet has an IP address in the memory table 60, the packet is transmitted via upstream port 50a. Wherein the packet has a new IP address for the origination address, the wireless content switch 10 authenticates the wireless client 125 transmitting the data packet by transmitting an authentication challenge via downstream port 50b (signal 325). The wireless client 125 responds to the authentication challenge by transmitting the RAI from the original SGSN 130 and the P-TMSI allocated by the original SGSN 130 (signal 330). From the P-TMSI and the RAI, the wireless client 10 determines the original SGSN 130 and transmits via upstream port 50a (signal 335) the P-TMSI to the original SGSN 130. Responsive thereto, the original SGSN 130 transmits the IMSI associated with the wireless client 125 to the wireless content switch 10 (signal 340). The wireless content switch 10 then authenticates the IMSI (signal 345) with the home location register (HLR) 152. Upon receipt of a signal indicating that the IMSI is authenticated and a subscriber profile at upstream port 50a (signal 350), the wireless content switch 10 then transmits (signal 355) the RAI associated with the WLAN 110 and a new P-TMSI to the wireless client 125. The foregoing subscriber profile, P-TMSI, RAI, and IP address are stored in a record 65 which is initialized and associated with the wireless client 125. Additionally, the wireless content switch 10 establishes a pipe (signal 360) to the GGSN 120 wherein data packets can be received and transmitted to the internet 115.

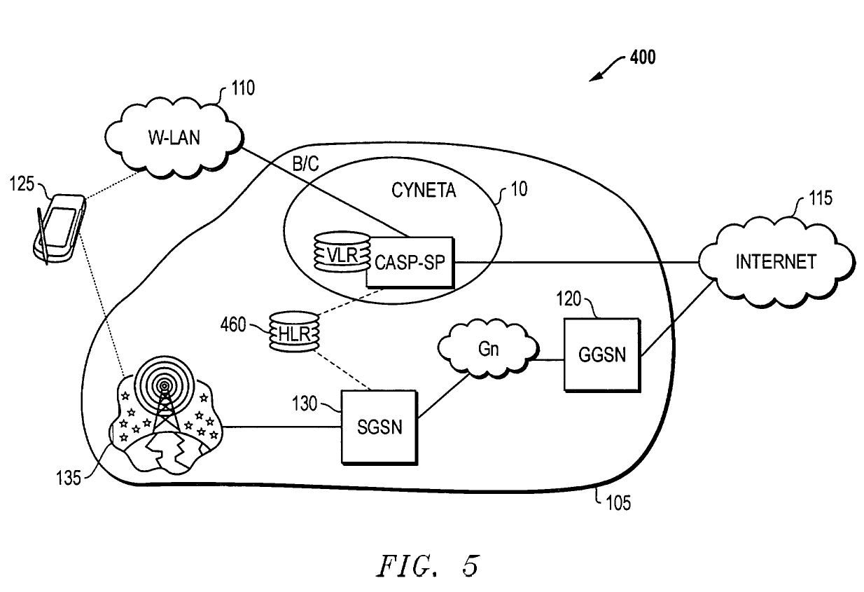

Referring now to FIG. 5, there is illustrated a block diagram of another communication network, referred to generally by the numeric reference 400. The communication network 400 includes both a wireless local area network 110 and a public wireless packet data services network 105. The wireless local area network 110 is interconnected to both the public wireless packet data service network 105 and the internet 115 via a wireless content switch 10.

The wireless content switch 10 is connected to the WLAN 110 via a downstream port 50b and the internet 115 via an upstream port 50a in a manner such that all signals that are passed between the WLAN 110 and the internet 115 are received at the wireless content switch 10. Additionally, the wireless content switch 10 can access a home location register (HLR) 460 associated with the public wireless packet data service network 105.

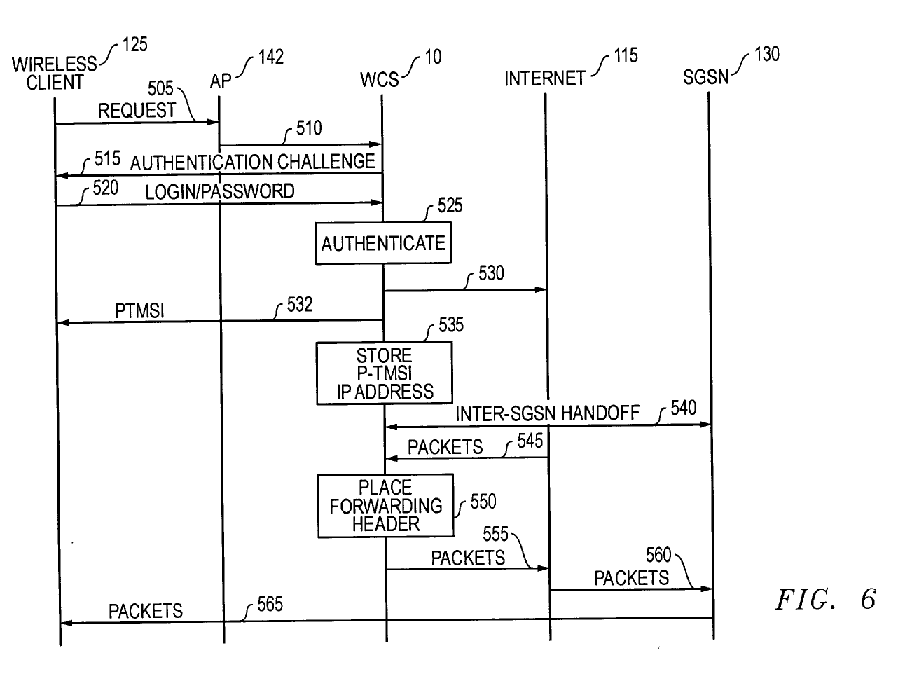

Referring now to FIG. 6, there is illustrated a signal flow diagram describing the operation of the communication network 100, wherein a wireless client 125 originates a wireless packet data session in the WLAN and moves outside the coverage area of the WLAN. A wireless client 125 initiates a data session with the WLAN 110 by transmitting a request message (signal 505) to the access point 142. Responsive thereto, the access point 142 attempts to establish a pipe to the internet via the wireless content switch 10 by establishing a pipe connection to the wireless content switch 10 (signal 510). The authentication capabilities of the access point 142 are preferably disabled.

The pipe connection between the access point 142 and the wireless client 10 is detected by the wireless content switch 10. Upon detection of the pipe, the wireless content switch 10 sends via downstream port 50b, an authentication challenge signal(s) (signal 515) to the wireless client 125 to establish and verify the identity of the subscriber associated with the wireless client 125. The wireless client 125 responds to the authentication challenge signal(s) 515 by transmitting a login identification and a password associated therewith (signal 520) which are received at downstream port 50b.

The wireless content switch 10 authenticates the wireless client 125 (action 525) using the login identification and password provided in signal 520 and matching the foregoing information to the information contained in a subscriber profile indicator 65a of a record 65 associated with a wireless client 125. During the authentication, the wireless content switch 10 correlates the login identification provided with the IMSI in the IMSI indicator 65b of the record 65 associated with the wireless client 125.

Upon authentication of the wireless client 125, the wireless content switch 10 completes the pipe (signal 530) to the internet 115. Additionally, the wireless content switch 10 transmits (signal 532) a P-TMSI via downstream port 65b to the wireless client 125. The wireless client 125 can then continue access the internet 115 via the WLAN 110. The wireless content switch 10 also stores the P-TMSI and the IP address associated with the wireless client 125 (action 535) in the P-TMSI indicator 65b and IP address indicator 65d. The wireless client 125 can then engage in a data transmission session over the internet.

When the wireless client 125 moves outside the coverage area of the WLAN 110, the wireless client 125 undergoes what is known as an inter-SGSN handoff (signals 540) from the wireless content switch 10 to SGSN 130 in the public wireless packet data network 105. During the handoff, wireless content switch 10 receives the identity of the SGSN 130. Responsive to receiving the identity of the SGSN 130, the wireless content switch 10 registers the SGSN 130 for forwarding all data packets which are directed to the wireless client 125 in the forwarding IP address indicator 65e of the record 65 associated with the wireless client 125.

As the wireless client 125 engages in the internet session with SGSN 130, data packets transmitted from the internet 115 are routed to the wireless content switch 10 (signals 545). The wireless content switch 10 examines the data packets for the destination IP address. The destination IP address is matched with a destination IP address of a particular IP address indicator 65d of a record 65. Wherein the record 65 contains a forwarding address in the forwarding IP address indicator 65e, the wireless content switch 10 places a forwarding header on the data packet (action 550) which indicates that the packet is to be routed to the SGSN 130 and transmits the data packet via upstream port 50a to the internet 115 (signal 555). The internet 115 routes the data packet to the SGSN 130 serving the wireless client 125 (signal 560). When the SGSN 130 receives the data packet, the SGSN 130 forwards the data packet to the wireless client 125 (signal 565).

Although the foregoing detailed description is presented with a degree of particularity, it is noted that the embodiments described therein are capable of numerous modifications, and substitutions, without departing from the spirit of the invention. Accordingly, the invention is limited only by the following claims, and equivalents thereof.

What is claimed is:

1. A method for servicing wireless clients in a first wireless packet data network, said method comprising:
receiving a request for internet access for a wireless client;
authenticating the wireless client; and
transmitting an identifier identifying the first wireless packet data network.

2. The method of claim 1, wherein receiving a request for internet access for the wireless client further comprises:
detecting establishment of a pipe from the first wireless packet data network.

3. The method of claim 1, wherein authenticating the wireless client further comprises:
transmitting an authentication challenge to the wireless client; and
receiving a login identification and a password from the wireless client.

4. The method of claim 1, wherein transmitting an identifier identifying the first wireless packet data network further comprises:
transmitting a routing area identifier to the wireless client.

5. The method of claim 1, further comprising transmitting a temporary identifier to the wireless client.

6. The method of claim 5, further comprising:
receiving the temporary identifier from a node associated with a second wireless packet data network;
transmitting a permanent identifier for the wireless client to the node.

7. The method of claim 6, wherein transmitting a permanent identifier for the wireless client to the node further comprises:
transmitting an International Mobile Subscriber Identifier for the wireless client to the node.

8. A method for providing access to a wired network, said method comprising:
receiving an identifier identifying a node in a first wireless packet data service network from a wireless client in a first wireless packet data service network;
transmitting a first identifier of the wireless client to the node identified by the identifier; and
receiving a second identifier of the wireless client from the node.

9. The method of claim 8, wherein receiving an identifier identifying the node further comprises:
receiving a routing area identifier from the wireless client identifying an SGSN.

10. The method of claim 8, wherein transmitting the first identifier of the wireless client to node further comprises:
transmitting a P-TMSI identifying the wireless client to the node identified by the identifier.

11. The method of claim 8, wherein receiving a second identifier from the node further comprises:
receiving an International Subscribing Identification Number identifying the wireless client.

12. The method of claim 8, further comprising:
authenticating the second identifier identifying the wireless client.

13. The method of claim 8, further comprising:
transmitting an identifier identifying a second wireless packet data network and a third identifier identifying the wireless client.

14. A wireless content switch for providing a wireless client of a wireless network access to a wired network, said wireless content switch comprising:
a processing unit for executing a plurality of executable instructions;
a bus coupled to the processing unit;
a memory coupled to the bus and processing unit, the memory for storing the plurality of executable instructions and for storing a plurality of records, each of said records associated with a corresponding plurality of wireless clients, wherein each of said plurality of records further comprises:
a first field for storing a first identifier identifying the wireless client associated with the record; and
a second field for storing a second identifier identifying the wireless client associated with the record;
an upstream port coupled to the bus, the upstream port in communication with the wired network; and
a downstream port coupled to the bus, the downstream port in communication with the wireless network.

15. The wireless content switch of claim 14, wherein the upstream port in communication with the wired network receives the first identifier, transmits the second identifier, and transmits an identifier identifying a first wireless packet data network.

16. The wireless content switch of claim 14, wherein the downstream port in communication with the wireless network receives the second identifier from a node in a second wireless packet data network and transmits the first identifier to the node.

17. A communication network including a wireless client of a wireless local area network and a wired network, the communication network comprising:
a wireless packet data network, the wireless packet data network for providing packet data services to a plurality of regions, the wireless packet data network further comprising:
a gateway node coupled to the wireless packet data network, wherein the gateway node is in communication with the wired network;
a support node associated with each region and coupled to the gateway node, each support node associated with a radio transceiver for transmitting and receiving signals from the wireless client; and
a home location register coupled to the support node, the home location register for storing the identity of all allowable wireless clients;
a wireless content switch coupled to the wireless packet data network and the wireless local area network, the wireless content switch for transmitting and receiving signals from the wireless packet data network and the wireless local area network;
wherein the wireless content switch allows the wireless client access to the wired network via the wireless packet data network; and
wherein the wireless content switch allows the wireless client to transfer from the wireless local area network to the wireless packet data network for access to the wired network.

18. The communication network of claim 17, wherein the wireless content switch allows the wireless client to transfer from the wireless packet data network to the wireless local area network.

19. The communication network of claim 17, wherein the wireless content switch further comprises:
a processing unit for executing a plurality of executable instructions;
a bus coupled to the processing unit;
a memory coupled to the bus and processing unit, the memory for storing the plurality of executable instructions and for storing a plurality of records, each of said records associated with a corresponding plurality of wireless clients;
executable instructions, when executed performing the steps of:
receiving a first identification signal from a support node, wherein the support node received a signal from the wireless client associated with the wireless local area network;
retrieving the stored record of the wireless client identified in the signal from the support node;
transmitting a second identification signal to the support node, wherein the second identification signal includes a second identifier and wherein the second identifier is compared to the records stored in the home location register, if the second identifier is a valid identifier then the wireless client is allowed access to the wired network.

20. The communication network of claim 19, wherein the first identifier is a temporary identifier and wherein the second identifier is a permanent identifier.
